(19) United States
(12) Patent Application Publication
(10) Pub. No.: US 2026/0206871 A1
(43) Pub. Date: Jul. 23, 2026

(54) AEROSOL-GENERATING DEVICE FOR HEATING AN AEROSOL-FORMING SUBSTRATE

(71) Applicant: Philip Morris Products S.A., Neuchatel (CH)

(72) Inventor: Gianluca PAGANO, Hung Hom (HK)

(73) Assignee: Philip Morris Products S.A., Neuchatel (CH)

(21) Appl. No.: 19/109,601

(22) PCT Filed: Sep. 13, 2023
(86) PCT No.: PCT/EP2023/075182

§ 371 Date: Mar. 7, 2025

(30) Foreign Application Priority Data
Sep. 14, 2022 (EP) 22195636.0

(51) Int. Cl. A24F 40/57; A24F 40/20; A24F 40/42; A24F 40/465; A24F 40/51; A24F 40/53; H05B 6/10

(52) U.S. Cl. CPC A24F 40/57; A24F 40/42; A24F 40/465; A24F 40/51; A24F 40/53; H05B 6/105; A24F 40/20

(57) ABSTRACT

An aerosol-generating device for heating an aerosol-forming substrate is provided, including: a device housing including a cavity to removably receive an aerosol-generating article including the substrate and a susceptor, the cavity including an insertion opening; a closure reversibly movable relative to the housing between closed and open positions, which respectively cover and do not obstruct the opening; an inductive heating arrangement to generate an alternating magnetic field within the cavity; a closure detector to detect when the closure is in or moves to the open position; and control circuitry connected to the arrangement and the closure detector and to: energize the arrangement in response to a signal from the closure detector, determine, during the energizing, a property of the arrangement that depends on a type, presence, absence, position, and/or movement of the susceptor, and detect a specific state related to the article based on the determined property of the arrangement.

The present invention relates to an aerosol-generating device comprising a cavity for removably receiving at least a portion of an aerosol-generating article, wherein the article includes a susceptor and an aerosol-forming substrate to be heated by interaction of the susceptor with an alternating magnetic field generated by the device. The invention further relates to an aerosol-generating system comprising such a device and an aerosol-generating article.

Aerosol-generating devices for heating aerosol-forming substrates that are capable to form inhalable aerosols when heated are generally known from prior art. Such devices may comprise a cavity for removably receiving at least a portion of an aerosol-generating article that includes the aerosol-forming substrate to be heated. For heating the substrate, the devices may further comprise an inductive heating arrangement configured to generate an alternating magnetic field within the cavity for inductively heating a susceptor that is part of the article and arranged in thermal proximity or direct physical contact with the substrate to be heated.

For various purposes, such devices may further comprise means for detecting one or more specific states related to the article based on a determined property or a determined change of a property of the inductive heating arrangement. For example, such means may detect the insertion of an article into the cavity or the type of an article inserted in the cavity. Using the heating arrangement for detecting such states typically requires to energize the heating arrangement. This is associated with additional power consumption, which in turn can significantly reduce the operating time of the device.

Therefore, it would be desirable to have an aerosol-generating device with the advantages of prior art solutions whilst mitigating their limitations. In particular, it would be desirable to have an aerosol-generating device using the heating arrangement for detecting one or more specific states related to the article which is improved over prior art solutions.

According to the invention there is provided an aerosol-generating device for heating an aerosol-forming substrate that is capable to form an inhalable aerosol when heated. The device comprises a device housing comprising a cavity for removably receiving at least a portion of an aerosol-generating article, wherein the article includes the aerosol-forming substrate and an inductively heatable susceptor for heating the substrate. The cavity comprises an insertion opening for inserting the article into the cavity. The device further comprises a closure reversibly movable relative to the device housing between a closed position, in which the closure covers the insertion opening, and an open position, in which the insertion opening is unobstructed by the closure. Furthermore, the device comprises an inductive heating arrangement configured to generate an alternating magnetic field within the cavity for inductively heating the susceptor of the article when the article is received in the cavity. In addition, the device comprises a closure detector arranged and configured to detect at least one of: when the closure is in the open position or when the closure moves from the closed position to the open position. The device further comprises a control circuitry operatively connected to the inductive heating arrangement and the closure detector and configured
to energize the inductive heating arrangement in response to a signal from the closure detector indicating that the closure is in the open position or moves from the closed position to the open position, respectively;
to determine, during energizing the inductive heating arrangement, at least one property or a change of at least one property of the inductive heating arrangement that depends on at least one of a type, a presence, an absence, a position or a movement of the susceptor in the cavity; and
to detect at least one specific state related to the article based on the determined property or the determined change of the property of the inductive heating arrangement.

Such a specific state may be one of an article type, an insertion, a presence, an absence, a position or a displacement of an article in the cavity. Accordingly, the control circuitry may be configured to detect at least one of an article type, an insertion, a presence, an absence, a position and a displacement of an article in the cavity based on the determined property or the determined change of the property of the inductive heating arrangement.

According to the present invention, state detection is based on the fact that the specific article type, the insertion, the presence, the extraction, and/or the absence of the article influences or modifies at least one property, in particular at least one electrical and/or magnetic property of the inductive heating arrangement. This is due to the field-induced interaction between the inductive heating arrangement and the susceptor, the effect of which on the property or the change of the at least one property depends on the specific properties of the susceptor (susceptor type), on the presence or absence of the susceptor in or from the cavity as well as on a movement and the actual position of the susceptor relative to the inductive heating arrangement, in particular relative to an inductor of the inductive heating arrangement.

The at least one property of the inductive heating arrangement may be any property having an associated parameter which depends on at least one of a type, a presence, an absence, a position and a movement of the susceptor in the cavity. For example, the at least one property may be a property having an associated parameter which has a different value in the presence of the susceptor as compared to the value in the absence of the susceptor. For example, the at least one property may be current, voltage, resistance, frequency, phase shift, flux, and inductance of the inductive heating arrangement.

Preferably, the at least one property or the change of at least one property determined by the control circuitry is a current or a change in current supplied to the inductive heating arrangement.

Likewise, the at least one property or the change of at least one property may be at least one of an equivalent resistance or an inductance of the inductive heating arrangement or a change in an equivalent resistance or a change in an inductance of the inductive heating arrangement, respectively. As used herein, the term “equivalent resistance” refers to the real part of a complex impedance defined as the ratio of the AC voltage supplied to the inductive heating arrangement to the measured AC current. Accordingly, the “equivalent resistance” may also be denoted as the resistive load of the inductive heating arrangement. Likewise, as used herein, the term “inductance” refers to the imaginary part of a complex impedance defined as the ratio of the supplied AC voltage to the measured AC current. Inductance, generally speaking, includes the property of an electric circuit to be susceptible to exterior electromagnetic influences.

The specific value of the at least one property or the change of the at least one property of the inductive heating arrangement may be due to a specific magnetic permeability and/or a specific electrical resistivity of the susceptor. That is, the susceptor within the aerosol-generating article may include a material having a specific magnetic permeability and/or a specific electrical resistivity. Preferably, the susceptor comprises an electrically conductive material. For example, the susceptor may comprise a metallic material. The metallic material may be, for example, one of aluminum, nickel, iron, or alloys thereof, for example, carbon steel or ferritic stainless steel. Aluminum has an electrical resistivity of about 2.65×10E-08 Ohm-meter, measured at room temperature (20° C.), and a magnetic permeability of about 1.256×10E-06 Henry per meter. Likewise, ferritic stainless steel has an electrical resistivity of about 6.9×10E-07 Ohm-meter, measured at room temperature (20° C.), and a magnetic permeability in a range of 1.26×10E-03 Henry per meter to 2.26×10E-03 Henry per meter.

According to the invention, it has been found that any state detection involving the heating arrangement consumes the least amount of energy if it is only actively energized when the state detection is actually needed. Furthermore, it has been found that many of the aforementioned states are to be detected at the start of a user experience shortly in advance to the actual heating operation of the device, that is, when the heating arrangement is actually not yet active but about to be used. In due consideration of this, it has been concluded that for devices having a moveable closure to reversibly cover and free the insertion opening of the cavity, opening of the closure may be a well suited indicator for the start of a user experience and, thus, may be a well suited trigger to start the state detection. Accordingly, the present invention suggests to detect when the closure of the cavity is in the open position or when the closure moves from the closed position to the open position and subsequently to start the state detection (by energizing the inductive heating arrangement) only in response to a signal indicating that the closure is in the open position or moves from the closed position to the open position, respectively.

Advantageously, using the opening of the closure as trigger does not require any additional user interaction with the device, such as pushing a button. Instead, this trigger advantageously exploits an action taken by the user at the start of a user experience anyway, namely, to enable the insertion of an aerosol-generating article into the cavity.

Moreover, using the inductive heating arrangement not only for heating purposes, but also for state detection advantageously enables to avoid additional assembly space for separate sensor means.

While opening of the closure may be a well suited indicator for the start of a user experience, closing of the closure may be a well suited indicator for the end of a user experience and, thus, may be a well suited trigger to stop energizing the inductive heating arrangement. Hence, the closure detector may be arranged and configured to further detect at least one of: when the closure is in the closed position or when the closure moves from the open position to the closed position. Accordingly, the control circuitry may be configured to stop energizing the inductive heating arrangement in response to a signal from the closure detector indicating that the closure is in the closed position or when the closure moves from the open position to the closed position, respectively.

In particular, the closure detector may be configured to detect both, the opening of the closure as well as the closing of the closure. Hence, the closure detector may be configured to detect at least one of: when the closure is in the open position or when the closure moves from the closed position to the open position, as well as at least one of when the closure is in the closed position or when the closure moves from the open position to the closed position. More particularly, the closure detector may comprise a first closure detector which is configured to detect at least one of: when the closure is in the open position or when the closure moves from the closed position to the open position, and a second detector separate from the first closure detector which is configured to detect at least one of when the closure is in the closed position or when the closure moves from the open position to the closed position.

In general, the closure detector may be any detector capable of reliably detecting the position and/or movement of the closure. For example, the closure detector may comprise or may be one of a magnetic closure detector, an optical closure sensor, a capacitive closure detector, an inducive closure detector and an electromechanical switch.

Where the closure detector is or comprises a magnetic closure detector, the magnetic closure detector may comprise at least one magnetic sensor stationarily arranged in the device housing and at least one associated permanent magnet attached to the closure such that the magnetic sensor senses a magnetic field of the associated permanent magnet when the closure is in or moves to the open position, in particular only when the closure is in the open position. In particular, the permanent magnet and the magnetic sensor may be arranged such that the magnetic sensor senses a magnetic field of the associated permanent magnet only when the closure is in the open position.

Alternatively, the magnetic closure detector may comprise at least one magnetic sensor stationarily arranged in the device housing and at least one associated permanent magnet attached to the closure such that the magnetic sensor senses a magnetic field of the associated permanent magnet when the closure is in or moves to the closed position, in particular only when the closure is in the closed position.

According to another alternative, the magnetic closure detector may comprise at least one permanent magnet attached to or arranged at/in the closure and at least two magnetic sensors stationarily arranged in the device housing such that one of the magnetic sensors (in particular a first magnetic sensor) senses a magnetic field of the permanent magnet, when the closure is in or moves to the open position, in particular only when the closure is in the open position, and the other one of the magnetic sensors (in particular a second magnetic sensor) senses a magnetic field of the permanent magnet when the closure is in or moves to the closed position, in particular only when the closure is in the closed position.

According to yet another alternative, the magnetic closure detector may comprise at least two permanent magnets attached to or arranged at/in the closure and at least two magnetic sensors stationarily arranged in the device housing such that one of the magnetic sensors (in particular a first magnetic sensor) senses a magnetic field of the one of the permanent magnets (in particular a first permanent magnet), when the closure is in or moves to the open position, in particular only when the closure is in the open position, and the other one of the magnetic sensors (in particular a second magnetic sensor) senses a magnetic field of the other one of the permanent magnets (in particular a second permanent magnet) when the closure is in or moves to the closed position, in particular only when the closure is in the closed position.

Advantageously, each of the aforementioned arrangements ensures that the opening or closing of the closure can be reliably detected, in particular without external interference.

To ensure an interference-free detection of the opening movement or the open position of the closure, the respective magnetic sensor for detecting the opening movement or the open position of the closure may be arranged next to the associated permanent magnet at a distance of at most 3 millimeters, in particular at most 2.5 millimeters, when the closure is in the open position. In addition, the respective magnetic sensor for detecting the opening movement or the open position of the closure may be distanced from the associated permanent magnet by at least 5 millimeters, in particular at least 7.5 millimeters, preferably at least 10 millimeter, more preferably at least 15 millimeter, when the closure is in the closed position.

Likewise, to ensure an interference-free detection of the closing movement or the closed position of the closure, the respective magnetic sensor for detecting the closing movement or the closed position of the closure may be arranged next to the associated permanent magnet at a distance of at most 3 millimeters, in particular at most 2.5 millimeters, when the closure is in the open position. In addition, the respective magnetic sensor for detecting the closing movement or the closed position of the closure may be distanced from the associated permanent magnet by at least 5 millimeters, in particular at least 7.5 millimeters, preferably at least 10 millimeter, more preferably at least 15 millimeter, when the closure is in the open position.

Preferably, the magnetic sensors for the various configurations discussed before may be Hall sensors.

Where the closure detector is or comprises an optical closure detector, the optical closure detector may comprise a light sensor for detecting light, in particular ambient light. The light sensor preferably is arranged such as to be at least partially covered by the closure or by a cover attached to/arranged at the closure when the closure is either in the open position or in the closed position, and unobstructed by the closure or by the cover attached to/arranged at the closure when the closure is in closed position or in the open position, respectively. In this configuration, the closure or the cover attached to/arranged at the closure advantageously serve as light shutters in front of the light sensor which are switched between light transmitting state and light blocking sate by the movement of the closure. The light sensor may thus generate a first signal which is indicative of the closure being in the open position, when the light sensor detects any light or light above a pre-defined intensity threshold, and otherwise a second signal which is indicative of the closure being in the closed position, when the light sensor detects no light or only light below the pre-defined intensity threshold. Preferably, the light to be detected by the light sensor is ambient light. Due to this, there is no need for an additional light source, which keeps the technical effort low.

As an alternative, the optical closure detector may be configured as light barrier. For this, the optical closure detector may comprise a light emitter and a light receiver for sensing light transmitted from the light emitter. The light emitter and the light receiver may be arranged such that light transmitted from the light emitter towards the light receiver is blocked by the closure or by a cover attached to/arranged at the closure when the closure is in the open position, and unblocked by the closure or by the cover attached to/arranged at the closure when the closure is in closed position. Likewise, the light emitter and the light receiver may be arranged such that light transmitted from the light emitter towards the light receiver is blocked by the closure or by a cover attached to/arranged at the closure when the closure is in the closed position, and unblocked by the closure or by the cover attached to/arranged at the closure when the closure is in the open position. Advantageously, by using a light barrier with an internal light emitter the closure detection is independent of ambient light and thus works in all lighting conditions, whether outdoors or indoors and regardless of day or night.

Where the closure detector is or comprises an electromechanical switch, the electromechanical switch may be activated by the closure or by an actuator attached to/arranged at the closure when the closure is in the open position or in the closed position, and deactivated by the closure or by the actuator attached to/arranged at the closure when the closure is in closed position or in the open position, respectively.

Alternatively or in addition, the electromechanical switch may be activated by the closure or by an actuator attached to/arranged at the closure when the closure moves from the open position to the closed position or from the closed position to the open position. Likewise, the electromechanical switch may be deactivated by the closure or by the actuator attached to/arranged at the closure when the closure moves from the closed position to the open position or from the open position to the closed position.

It is also possible that the closure detector comprises two electromechanical switches, wherein one of the electromechanical switches may be activated by the closure or by an actuator attached to/arranged at the closure when the closure is in the open position or moves to the open position, and wherein the other one of the electromechanical switches may be activated by the closure or by the same actuator attached to/arranged at the closure or another actuator attached to/arranged at the closure when the closure is in the closed position or moves to the closed position.

In any of these configurations of the electromechanical switch, the actuator attached to/arranged at the closure may be a mechanical pusher or a catch or the like. Likewise, the closure itself or a portion of the closure may serve as a mechanical pusher or a catch or the like. As used herein, the term “electromechanical switch” refers to a mechanically driven electrical component that can disconnect or connect the conducting path in an electrical circuit, interrupting the electric current or diverting it from one conductor to another. In particular, the electromechanical switch may comprise one or more sets of movable electrical contacts connected to external circuits. Thus, the switch facilitates to generate at least two signals, one being indicative of the switch being activated, the other one being indicative of the switch being deactivated.

In general, the closure may be of any type suitable to open and close the insertion opening of the cavity.

According to a first embodiment, the closure may be a sliding closure which is slidably guided on the device housing between the open position and the closed position. For example, the sliding closure may be slidably guided on the device housing by means of one or more guide rails, in particular one or more pairs of corresponding guide rails, wherein one guide rail of such a pair of guide rails is arranged at the closure and the corresponding other guide rail of that pair of guide rails is arranged at the device housing. Likewise, the sliding closure may be slidably guided on the device housing by means of or one or more guide grooves and correspondingly formed guide members which are slidably guided in the guide groove in a form-fitting manner. For example, the closure may comprise one or more guide members each of which is slidably guided in a correspondingly formed guide groove on the device housing in a form-fitting manner. Vice versa, one or more guide members may be arranged on the device housing each of which slidably guided in a correspondingly formed guide groove on the closure.

According to a second embodiment, the closure may be a pivotal closure pivotally mounted to the device housing. For this, the aerosol-generating device may comprise a pivot mechanism, such as one or more hinges or one or more pivot arms, pivotably coupling the closure to the device housing.

According to a third embodiment, the closure may be an iris diaphragm closure.

The at least one property or the change of the at least one property of the inductive heating arrangement may be observed by measuring a change in a parameter of the inductive heating arrangement. The parameter may be measured either directly or indirectly. For example, the presence or absence of an article may be determined by measuring such a parameter and observing that the parameter has a different value in the presence of the article, that is, in the presence of the susceptor, as compared to the value in the absence of the article, that is, in absence of the susceptor.

Preferably, the parameter may be a current. Likewise, the current may be the property itself that is determined by the control circuitry. In particular, the at least one property or the change of at least one property determined by the control circuitry may be a current or a change in current supplied to the inductive heating arrangement. Accordingly, the control circuitry may be configured to detect the presence of the susceptor in the cavity when (or in response to) the current or the change in current supplied to the inductive heating arrangement breaching or reaching a threshold, for instance when the current or change in current exceeds of falls below a threshold.

Where the property or the parameter indicative of the property is a current, the control circuitry may comprise a measurement device for measuring a current corresponding to or being indicative of the at least one property or the change of the at least one property of the inductive heating arrangement. The property or the parameter indicative of the property may be a current supplied from a power supply of the device, in particular a DC current supplied from a DC power supply of the device, to the inductive heating arrangement. Accordingly, the control circuitry may comprise a measurement device arranged and configured for measuring a current supplied from a power supply of the device, in particular a DC current supplied from a DC power supply of the device to the inductive heating arrangement. The measurement device may comprise a current measurement device, in particular a DC current measurement device arranged in series connection between a power supply, in particular the DC power supply of the device, and the inductive heating arrangement. For example, the measurement device may comprise a resistance and a shunt amplifier. In use, when an aerosol-generating article is inserted into the cavity of the aerosol-generating device, the susceptor being or becoming present in the cavity increases the equivalent resistance due to an increase of the resistive load. This in turn causes a decrease of the (DC) current feeding the inductive heating arrangement. The decrease of the (DC) current is detected by the current measurement device of the control circuitry which subsequently may activate a heating operation of the inductive heating arrangement for heating the substrate. Vice versa, when an aerosol-generating article is absent from the cavity, the equivalent resistance is lower due to the lower resistive load in absence of the susceptor. This in turn is related to a higher (DC) current feeding the inductive heating arrangement which can be detected by the current measurement device of the control circuitry, thus indicating the absence of an article from the cavity. Likewise, when an aerosol-generating article is displaced within the cavity the equivalent resistance may change to a higher or a lower value due to a respective change of the resistive load which is related to the actual position of the susceptor relative to the heating arrangement, in particular an inductor of the heating arrangement. The change of the resistive load causes a change of the (DC) current feeding the inductive heating arrangement which again can be detected by the current measurement device, thus indicating the displacement or a specific position of an article within the cavity.

In order to further reduce the energy consumption and, thus, to further increase the overall operation time of the device as compared to other solutions, the inductive heating arrangement may be operated in a pulsed mode for the purpose of state detection. Accordingly, the control circuitry may be configured to generate power pulses for intermittently, in particular periodically powering on the inductive heating arrangement and to determine during one or more power pulses the at least one property or the change of the at least one property of the inductive heating arrangement. In order to generate such power pulses, the control circuitry may comprise a switch configured and arranged to control a supply of power from a power supply of the device, in particular a DC power supply, to the inductive heating arrangement. The switch may be intermittently closed and opened such as to intermittently power on the inductive heating arrangement in order to allow detecting the at least one specific state related to the article based on the determined property or the determined change of the property of the inductive heating arrangement.

Depending on the specific state detected by the control circuitry, the control circuitry may be configured to take further actions, in particular to start, enable or disable various operational modes, for example, a heating operation.

Preferably, the control circuitry is configured to start a heating operation of the inductive heating arrangement in response to detecting the insertion of an article into the cavity. Advantageously, this enhances the user's convenience as the heating operation automatically starts upon insertion of an article into the cavity without the need of any further user input. In particular, the user experience starts immediately as it is known from conventional cigarettes. In addition or alternatively, it is also possible that a heating operation of the inductive heating arrangement is activated manually, that is, by a user input, for example by pressing a button.

The control circuitry may be further configured to disable a heating operation of the inductive heating arrangement in response to detecting at least one of the absence of an article from the cavity or a displacement of an article within the cavity or an unsuitable article type having been inserted into the cavity. Advantageously, this prevents a user of the device from starting a heating operation without any article being present in the cavity, or with an article being not properly placed within the cavity or with an unsuitable article type. As a result, damages and malfunctions of the device can be effectively prevented.

The control circuit may be further configured to stop a heating operation of the inductive heating arrangement subject to various conditions. In particular, the control circuit may be configured to stop heating operation of the device in response to at least one of detecting a pre-determined number of puffs, detecting that a pre-determined heating time has elapsed, or receiving a user input.

The control circuitry may also be configured to verify the insertion of an article into the cavity or the absence of an article from the cavity by energizing the inductive heating arrangement, in particular by generating at least one verifying power pulse, a pre-determined period of time after a first detection of a specific value of a respective property or a specific change of a respective property of the inductive heating arrangement and by re-detecting the specific value or change of the respective property of the inductive heating arrangement.

In case the control circuitry is configured to energize the inductive heating arrangement in a pulsed mode by generating power pulses for intermittently powering on the inductive heating arrangement, the control circuitry may comprise a switch configured and arranged to control a supply of power from a power supply of the device, in particular a DC power supply, to the inductive heating arrangement. For this, the switch may be intermittently closed and opened such as to intermittently power on the inductive heating arrangement.

The generation of power pulses may also be used to realize a pulsed heating operation in which the inductive heating arrangement is intermittently powered on and off in order to heat the susceptor in a pulse mode. The previously mentioned switch of the control circuitry can also be used for this purpose. In particular, the heating mode may include a pulse width modulation of the heating power pulses for controlling the heating temperature.

It is also possible that during the heating operation of the device the switch may be permanently closed to continuously apply a DC voltage from the DC power supply to the inductive heating arrangement. Accordingly, this mode may be denoted as continuous heating operation.

During heating operation, the control circuitry may also be able to detect the extraction of an article from the cavity by detecting a change of at least one property of the inductive heating arrangement due to the susceptor becoming absent from the cavity when an aerosol-generating article is extracted from the cavity.

Power pulses generated for detection the at least one specific state related to the article, may be denoted as probe power pulses. Accordingly, the control circuitry may be configured to generate probe power pulses. Likewise, power pulses generated for heating the susceptor in a pulsed mode may be denoted as heating power pulses. Accordingly, the control circuitry may be configured to generate heating power pulses.

In general, the probe power pulse and the heating power pulses may be identical. It is also possible that the probe power pulses and the heating power pulses may differ from each other by at least one property of the power pulses, in particular by at least one of the pulse pattern, the amplitude of the power pulse, the pulse duration and the time interval between two consecutive power pulses. In particular, the amplitude of the heating power pulses may be larger than the amplitude of the probe power pulses. In addition, the probe power pulses may have a fixed pulse pattern, in particular a fixed periodicity. In contrast, the heating power pulses may have an unfixed, in particular variable pulse pattern, for example in order to realize a pulse width modulation of the heating power.

In general, the pulse duration and the time interval between two consecutive power pulses, in particular probe power pulses, should be selected such as to balance the effect of energy depletion and user experience performance. The pulse duration should be kept as short as possible, but still long enough to provide a reliable measurement of the at least one property or the change of the at least one property of the inductive heating arrangement. Likewise, the higher the time interval between two consecutive power pulses, in particular probe power pulses, the lower the energy depletion. However, the time interval between two consecutive power pulses, in particular probe power pulses, should not be too long, otherwise, the state detection could be too time consuming.

Taking these considerations into account, the power pulses, in particular probe power pulses, may have a pulse duration in a range between 1 microsecond and 500 microseconds, in particular between 10 microseconds and 300 microseconds, preferably between 15 microseconds and 120 microseconds, most preferably between 30 microseconds to 10 microseconds. As used herein, the term “pulse duration” denotes the time interval during which the heating arrangement is powered on, in particular during which the switch mentioned above is closed. The time interval between two consecutive power pulses, in particular probe power pulses, may be in a range between 50 milliseconds and 2 seconds, in particular between 100 milliseconds and 2 seconds, preferably between 500 milliseconds and 1 second. The sum of the pulse duration time and the time interval between two consecutive power pulses may be denoted as the polling time, that is, the difference in time between the start of a pulse and the start of the following one. The polling time may be in a range between 50 milliseconds and 2.5 seconds, in particular between 51 milliseconds and 2.5 milliseconds, more particularly between 100 milliseconds and 2 seconds, preferably between 500 milliseconds and 1 second.

Preferably, he power pulses used for state detection, in particular the probe power pulses, are generated for a predetermined period of time. That is, the state detection may last a finite predetermined period of time. In case a specific state, such as the insertion of an article into the cavity, has not been detected within the predetermined period of time, the state detection may be stopped, that is, the generation of the power pulses may be turned off in order to safe electrical power, as described above. Likewise, in case a specific state is detected within the predetermined period of time, the state detection and thus the generation of the power pulses may be stopped, in particular immediately, in response to detecting a specific state.

The inductive heating arrangement may be configured to generate a high-frequency alternating magnetic field. As referred to herein, the high-frequency alternating magnetic field may be in the range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz).

For generating the alternating magnetic field, the inductive heating arrangement may comprise DC/AC converter connected to the DC power supply. The DC/AC converter may include an LC network. For example, the DC/AC converter may comprise a Class-C power amplifier or a Class-D power amplifier or Class-E power amplifier. In particular, the DC/AC converter may comprise a transistor switch and a transistor switch driver circuit and an LC network. The LC network may comprise a series connection of a capacitor and an inductor, and wherein the inductor is configured and arranged to generate the alternating magnetic field within the cavity, in particular for inductively heating the susceptor and for article detection. The LC network may further comprise a shunt capacitor in parallel to the transistor switch. In addition, DC/AC converter may comprise a choke inductor for supplying a DC supply voltage +V_DC from to the DC power supply.

The inductor for generating the alternating magnetic field within the cavity may comprise at least one induction coil, in particular a single induction coil or a plurality of induction coils. The number of induction coils may depend on the size and/or number of susceptors. The induction coil or coils may have a shape matching the shape of the one or more susceptors in the aerosol-generating article. Likewise, the induction coil or coils may have a shape to conform to a shape of a housing of the aerosol-generating device. The at least one induction coil may be a helical coil or flat planar coil, in particular a pancake coil or a curved planar coil. The at least one induction coil may be wound around a preferably cylindrical coil support, for example a ferrite core.

The control circuit may further be configured to control the overall operation of the aerosol-generating device. The control circuitry and at least parts of the inductive heating arrangement may be integral part of an overall electrical circuitry of the aerosol-generating device.

The control circuitry may comprise a microprocessor, for example a programmable microprocessor, a microcontroller, or an application specific integrated chip (ASIC) or other electronic circuitry capable of providing control. The microprocessor may be configured to at least one of: to control the switch used to generate power pulses for intermittently powering on the inductive heating arrangement, to read out the measurement device for measuring the current supplied from the power supply to the inductive heating arrangement (if present), and to control the transistor switch driver circuit of the inductive heating arrangement (if present).

The control circuitry may be or may be part of an overall controller of the aerosol-generating device. The controller and at least a portion of the induction source, in particular the induction source apart from the inductor, may be arranged at a common printed circuit board. This proves particularly advantageous with regard to a compact design of the heating arrangement.

Preferably, the aerosol-generating device is a puffing device for generating an aerosol that is directly inhalable by a user through the user's mouth. In particular, the aerosol-generating device is a hand-held aerosol-generating device.

As mentioned before, the aerosol-generating device preferably comprises a power supply, in particular a DC power supply, such as a battery. The power supply may require recharging, that is, the power supply may be rechargeable. The power supply may have a capacity that allows for the storage of enough energy for one or more user experiences. For example, the power supply may have sufficient capacity to allow for the continuous generation of aerosol for a period of around six minutes or for a period that is a multiple of six minutes. In another example, the power supply may have sufficient capacity to allow for a predetermined number of puffs or discrete activations of the induction source.

As used herein, the direction in which the aerosol-generating article is inserted into the cavity is denoted as insertion direction. Preferably, the insertion direction corresponds to the extension of a length axis, in particular a center axis of the cavity. Upon insertion into the cavity, at least a portion of the aerosol-generating article may still extend outwards through the insertion opening. The outwardly extending portion preferably is provided for interaction with a user, in particular for being taken into a user's mouth. Hence, during use of the device, the insertion opening may be close to the user's mouth. Accordingly, as used herein, sections close to the insertion opening or close to a user's mouth in use of the device, respectively, are denoted with the prefix “proximal”. Sections which are arranged further away are denoted with the prefix “distal”. With regard to this convention, the cavity may be arranged or located in a proximal portion of the aerosol-generating device. The insertion opening may be arranged or located at a proximal end of the aerosol-generating device, in particular at a proximal end of the cavity. At a distal end, the cavity may comprise a bottom opposite to the insertion opening.

The aerosol-generating device may comprise an air path extending from at least one air inlet into the cavity. That is, the aerosol-generating device may comprise at least one air inlet in fluid communication with the cavity. When an aerosol-generating article is inserted into the cavity, the air path may further extend through the aerosol-forming substrate within the article and a mouthpiece of the article into a user's mouth. Preferably, the air inlet is realized at the insertion opening of the cavity used for inserting the article into the cavity. Accordingly, when the article is received in the cavity, air may be drawn into the cavity at the rim of the insertion opening and may further pass through an airflow passage formed between the outer circumference of the aerosol-generating article and at least one or more portions of the inner surface of the cavity.

In general, the cavity may have any suitable shape. In particular, the shape of the cavity may correspond to the shape of the aerosol-generating article to be received therein. Preferably, the cavity may have a substantially cylindrical shape or a tapered shape, for example, a substantially conical or a substantially frustoconical shape. The cavity may have any suitable cross-section as seen in a plane perpendicular to a length axis of the cavity or perpendicular to the insertion direction of the article. In particular, the cross-section of the cavity may correspond to the shape of the aerosol-generating article to be received therein. Preferably, the cavity has a substantially circular cross-section. Alternatively, the cavity may have a substantially elliptical cross-section or a substantially oval cross-section or a substantially square cross-section or a substantially rectangular cross-section or a substantially triangular cross-section or a substantially polygonal cross-section. As used herein, the above mentioned shapes and cross-sections preferably refer to a shape or a cross-section of the cavity without considering any protrusions at the inner surface of the cavity.

The inductor may be arranged such as to surround at least a portion of the cavity or at least a portion of the inner surface of the cavity, respectively. The inductor may be, for example a helical coil, arranged within a side wall of the cavity. In particular, the inductor may be integrated in a wall defining the cavity. For example, the inductor may be integrated in a side wall of the cavity, in particular such as to surround at least a portion of the interior of the cavity.

The cavity may comprise a plurality of protrusions extending in the interior of the cavity. Preferably, the protrusions are distanced from each other such that an airflow passage is formed in between neighboring protrusions, that is, by the interstices (free space) between neighboring protrusions. In addition, the plurality or protrusions may be configured to contact at least a portion of the aerosol-generating article for retention of the aerosol-generating article in the cavity. The plurality of protrusions may comprise or may be formed as a rib. Preferably, the one or more ribs extend along a direction of a length axis, in particular a center axis of the cavity.

The present invention further relates to an aerosol-generating system comprising an aerosol-generating device according to any one of the preceding claims and an aerosol-generating article for use with the aerosol-generating device, wherein the aerosol-generating article is removably receivable in the cavity of the device and comprises at least one aerosol-forming substrate and at least one inductively heatable susceptor for heating the substrate by interaction of the susceptor with the alternating magnetic field provided by the inductive heating arrangement of the device.

As used herein, the term “aerosol-generating article” refers to an article comprising at least one aerosol-forming substrate that, when heated, releases volatile compounds that can form an aerosol. Accordingly, the aerosol-generating article may be denoted as a heated aerosol-generating article or an aerosol-generating article for heating. That is, the aerosol-generating article preferably comprises at least one aerosol-forming substrate that is intended to be heated rather than combusted in order to release volatile compounds that can form an aerosol. The aerosol-generating article may be a consumable, in particular a consumable to be discarded after a single use.

As used herein, the term “aerosol-forming substrate” relates to a substrate capable of releasing volatile compounds that can form an aerosol when heated. The aerosol-forming substrate may be a solid aerosol-forming substrate or a gel-like aerosol-forming substrate or a liquid aerosol-forming substrate or a combination thereof. The aerosol-forming substrate may comprise a tobacco-containing material containing volatile tobacco flavor compounds, which are released from the substrate upon heating. Alternatively or additionally, the aerosol-forming substrate may comprise a non-tobacco material. The aerosol-forming substrate may further comprise an aerosol former. Examples of suitable aerosol formers are glycerin and propylene glycol. The aerosol-forming substrate may also comprise other additives and ingredients, such as nicotine or flavoring substances. In particular, a liquid aerosol-forming substrate may include water, solvents, ethanol, plant extracts and natural or artificial flavors. The aerosol-forming substrate may also be a paste-like material, a sachet of porous material comprising aerosol-forming substrate, or, for example, loose tobacco mixed with a gelling agent or sticky agent, which could include a common aerosol former such as glycerin, and then is compressed or molded into a plug.

The aerosol-generating article may be a tobacco article. In particular, the article may be a rod-shaped article, preferably a cylindrical rod-shaped article, which may resemble conventional cigarettes. The aerosol-generating article may have a circular or elliptical or oval or square or rectangular or triangular or a polygonal cross-section.

As an example, the aerosol-generating article may be a rod-shaped article. In particular a cylindrical article comprising one or more of the following elements: a distal front plug element, a substrate element, a first tube element, a second tube element, and a filter element.

The substrate element preferably comprises the at least one aerosol-forming substrate to be heated and the susceptor in thermal contact with or thermal proximity to the aerosol-forming substrate. The substrate element may have a length of 10 millimeter to 14 millimeter, for example, 12 millimeter.

As used herein, the term “susceptor” refers to an element comprising a material that is capable of being inductively heated within an alternating magnetic field. This may be the result of at least one of hysteresis losses or eddy currents induced in the susceptor, depending on the electrical and magnetic properties of the susceptor material.

The first tube element is more distal than the second tube element. Preferably, the first tube element is proximal of the substrate element, whereas the second tube element is proximal of the first tube element and distal of the filter element, that is, between the first tube element and the filter element. At least one of the first tube element and the second tube element may comprise a central air passage. A cross-section of the central air passage of the second tube element may be larger than a cross-section of the central air passage of the first tube element. Preferably, at least one of the first tube element and the second tube element may comprise a hollow cellulose acetate tube. At least one of the first tube element and the second tube element may have a length of 6 millimeter to 10 millimeter, for example, 8 millimeters.

The filter element preferably serves as a mouthpiece, or is part of a mouthpiece together with the second tube element. As used herein, the term “mouthpiece” refers to a portion of the article through which the aerosol exits the aerosol-generating article. The filter element may have a length of 10 millimeter to 14 millimeter, for example, 12 millimeter.

The distal front plug element may be used to cover and protect the distal front end of the substrate element. The distal front plug element may have a length of 3 millimeter to 6 millimeter, for example, 5 millimeter. The distal front plug element may be made of the same material as the filter element

All of the aforementioned elements may be sequentially arranged along a length axis of the article in the above described order, wherein the distal front plug element preferably is arranged at a distal end of the article and the filter element preferably is arranged at a proximal end of the article. Each of the aforementioned elements may be substantially cylindrical. In particular, all elements may have the same outer cross-sectional shape and/or dimensions.

In addition, the elements may be circumscribed by one or more outer wrappers such as to keep the elements together and to maintain the desired cross-sectional shape of the rod-shaped article. Preferably, the wrapper is made of paper. The wrapper may further comprise adhesive that adheres the overlapped free ends of the wrapper to each other. For example, the distal front plug element, the substrate element and the first tube element may be circumscribed by a first wrapper, and the second tube element and the filter element may be circumscribed by a second wrapper. The second wrapper may also circumscribe at least a portion of the first tube element (after being wrapped by the first wrapper) to connect the distal front plug element, the substrate element and the first tube element being circumscribed by a first wrapper to the second tube element and the filter element. The second wrapper may comprise perforations around its circumference.

Further features and advantages of the aerosol-generating system and the aerosol-generating article according to the present invention have already been described above with regard to aerosol-generating device according to the present invention and equally apply.

The invention is defined in the claims. However, below there is provided a non-exhaustive list of non-limiting examples. Any one or more of the features of these examples may be combined with any one or more features of another example, embodiment, or aspect described herein.

Example Ex1 An aerosol-generating device for heating an aerosol-forming substrate that is capable to form an inhalable aerosol when heated, the device comprising:
a device housing comprising a cavity for removably receiving at least a portion of an aerosol-generating article, the article including the aerosol-forming substrate and an inductively heatable susceptor for heating the substrate, wherein the cavity comprises an insertion opening for inserting the article into the cavity;
a closure reversibly movable relative to the device housing between a closed position, in which the closure covers the insertion opening, and an open position, in which the insertion opening is unobstructed by the closure;
an inductive heating arrangement configured to generate an alternating magnetic field within the cavity for inductively heating the susceptor of the article when the article is received in the cavity;
a closure detector arranged and configured to detect at least one of: when the closure is in the open position or when the closure moves from the closed position to the open position; and
a control circuitry operatively connected to the inductive heating arrangement and the closure detector and configured
   to energize the inductive heating arrangement in response to a signal from the closure detector indicating that the closure is in the open position or moves from the closed position to the open position, respectively;
   to determine—during energizing the inductive heating arrangement—at least one property or a change of at least one property of the inductive heating arrangement that depends on at least one of a type, a presence, an absence, a position and a movement of the susceptor in the cavity; and
   to detect at least one specific state related to the article based on the determined property or the determined change of the property of the inductive heating arrangement.

Example Ex2 The aerosol-generating device according to example Ex1, wherein the control circuitry is configured to detect at least one of an article type, an insertion, a presence, an absence, a position and a displacement of an article in the cavity based on the determined property or the determined change of the property of the inductive heating arrangement.

Example Ex3 The aerosol-generating device according to any one of the preceding examples, wherein the control circuitry is configured to generate power pulses for intermittently powering on the inductive heating arrangement and to determine during one or more power pulses the at least one property or the change of the at least one property of the inductive heating arrangement.

Example Ex4 The aerosol-generating device according to any one of the preceding examples, wherein the closure detector is arranged and configured to further detect at least one of: when the closure is in the closed position or when the closure moves from the open position to the closed position.

Example Ex5 The aerosol-generating device according to example Ex4, wherein the control circuitry is configured to stop energizing the inductive heating arrangement in response to a signal from the closure detector indicating that the closure is in the closed position or when the closure moves from the open position to the closed position, respectively.

Example Ex6 The aerosol-generating device according to any one of the preceding examples, wherein the closure detector comprises one of a magnetic closure detector, an optical closure sensor, a capacitive closure detector, an inducive closure detector and an electromechanical switch.

Example Ex7 The aerosol-generating device according to example Ex6, wherein for detecting when the closure is in the open position or when the closure moves from the closed position to the open position, the magnetic closure detector comprises at least one magnetic sensor stationarily arranged in the device housing and at least one associated permanent magnet attached to the closure such that the magnetic sensor senses a magnetic field of the associated permanent magnet when the closure is in or moves to the open position, in particular only when the closure is in the open position.

Example Ex8 The aerosol-generating device according to example Ex7, wherein the at least one magnetic sensor is arranged next to the at least one associated permanent magnet at a distance of at most 3 millimeters, in particular at most 2.5 millimeters, when the closure is in the open position.

Example Ex9 The aerosol-generating device according any one of example Ex7 or example 8, wherein the at least one magnetic sensor is distanced from the associated permanent magnet by at least 5 millimeters, in particular at least 7.5 millimeters, preferably at least 10 millimeter, more preferably at least 15 millimeter, when the closure is in the closed position.

Example Ex10 The aerosol-generating device according to example Ex6, wherein the optical closure detector comprises a light sensor for detecting light, in particular ambient light, wherein the light sensor is arranged such as to be at least partially covered by the closure or by a cover attached to or arranged at the closure when the closure is in the open position or in the closed position, and unobstructed by the closure or by the cover attached to or arranged at the closure when the closure is in closed position or in the open position, respectively.

Example Ex11 The aerosol-generating device according to example Ex6, wherein the optical closure detector comprises a light emitter and a light receiver for sensing light transmitted from the light emitter, wherein the light emitter and the light receiver are arranged such that light transmitted from the light emitter towards the light receiver is blocked by the closure or by a cover attached to or arranged at the closure when the closure is in the open position or in the closed position, and unblocked by the closure or by the cover attached to the closure when the closure is in closed position or in the open position, respectively.

Example Ex12 The aerosol-generating device according to example Ex6, wherein the electromechanical switch is activated by the closure or by an actuator attached to or arranged at the closure when the closure is in the open position or in the closed position, and deactivated by the closure or by the actuator attached to the closure when the closure is in closed position or in the open position, respectively.

Example Ex13 The aerosol-generating device according to example Ex6, wherein the electromechanical switch is activated by the closure or by an actuator attached to or arranged at the closure when the closure moves from the open position to the closed position or when the closure moves from the closed position to the open position.

Example Ex14 The aerosol-generating device according to example Ex13, wherein the electromechanical switch is deactivated by the closure or by the actuator attached to or arranged at the closure when the closure moves from the closed position to the open position or when the closure moves from the open position to the closed position.

Example Ex15 The aerosol-generating device according to any one of examples Ex1 to Ex14, wherein the closure is a sliding closure slidably guided on the device housing between the open position and the closed position.

Example Ex16 The aerosol-generating device according to any one of examples Ex1 to Ex14, wherein the closure is a pivotal closure pivotally mounted to the device housing.

Example Ex17 The aerosol-generating device according to any one of examples Ex1 to Ex14, wherein the closure is an iris diaphragm closure.

Example Ex18 The aerosol-generating device according to any one of the preceding examples, wherein the at least one property or the change of at least one property determined by the control circuitry is a current or a change in current supplied to the inductive heating arrangement.

Example Ex19 The aerosol-generating device according to any one of the preceding examples, wherein the control circuitry comprises a measurement device for measuring a current corresponding to or being indicative of the at least one property or the change of the at least one property of the inductive heating arrangement.

Example Ex20 The aerosol-generating device according to any one of example Ex18 or example Ex19, wherein the control circuitry is configured to detect the presence of the susceptor in the cavity when (or in response to) the current or the change in current supplied to the inductive heating arrangement breaching or reaching a threshold, for instance when the current or change in current exceeds of falls below a threshold.

Example Ex21 The aerosol-generating device according to any one of the preceding examples, wherein the control circuitry is configured to start a heating operation of the inductive heating arrangement in response to detecting the insertion of an article into the cavity.

Example Ex22 The aerosol-generating device according to any one of the preceding examples, wherein the control circuitry is configured to disable a heating operation of the inductive heating arrangement in response to detecting the absence of an article from the cavity.

Example Ex23 An aerosol-generating system comprising an aerosol-generating device according to any one of the preceding examples and an aerosol-generating article for use with the aerosol-generating device, wherein the aerosol-generating article is removably receivable in the cavity of the device and comprises at least one aerosol-forming substrate and at least one inductively heatable susceptor for heating the substrate by interaction of the susceptor with the alternating magnetic field provided by the inductive heating arrangement of the device.

The invention will be further described, by way of example only, with reference to the accompanying drawings, in which:

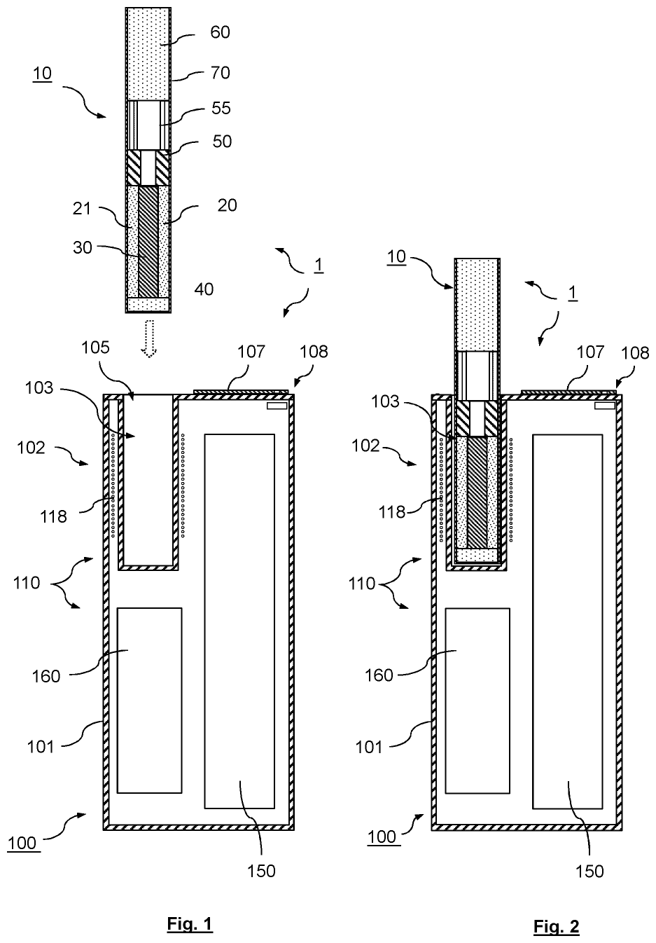

FIGS. 1-2 schematically illustrate an exemplary embodiment of an aerosol-generating system according to the present invention, including an aerosol-generating device and an aerosol-generating article for use with the device;

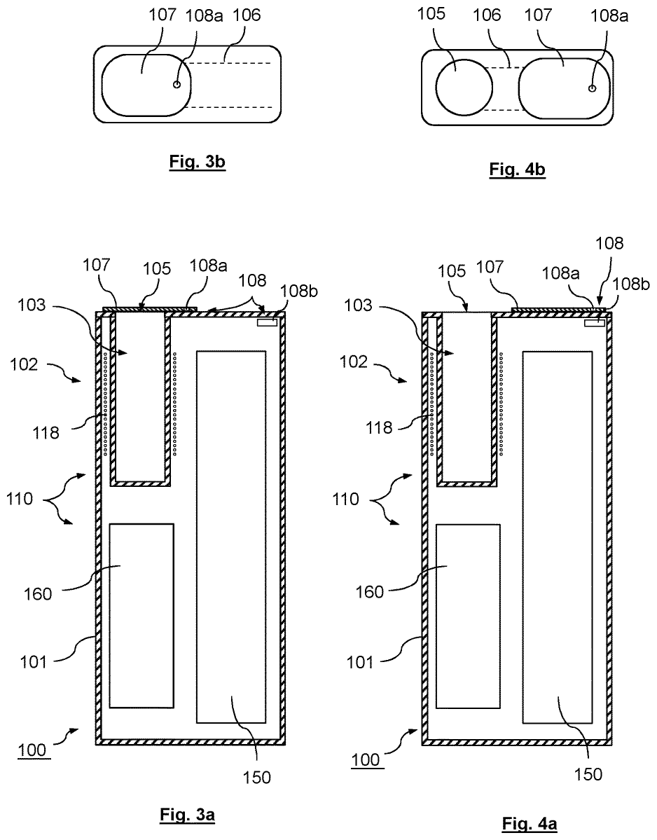

FIGS. 3a-b show the aerosol-generating device of the system according to FIG. 1 and FIG. 2 with the closure of the cavity being in the closed position;

FIGS. 4a-b show the aerosol-generating device of the system according to FIG. 1 and FIG. 2 with the closure of the cavity being in the open position;

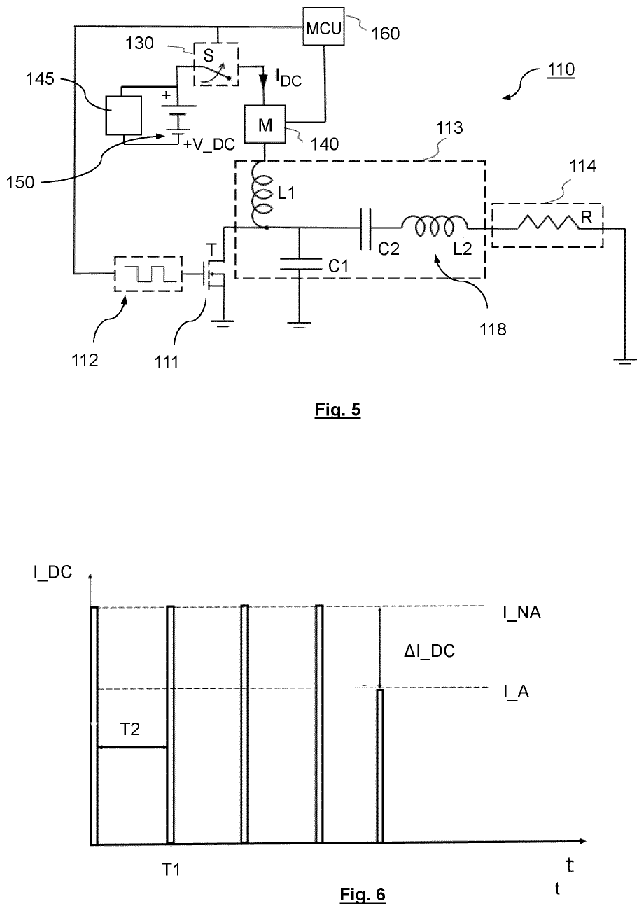

FIG. 5 schematically illustrates the inductive heating arrangement of the aerosol-generating device according to FIGS. 1 and 2; and

FIG. 6 shows details of a pulsed operation of the inductive heating arrangement shown in FIG. 5.

FIG. 1 and FIG. 2 schematically illustrate an exemplary embodiment of an aerosol-generating system 1 according to the present invention which is configured to generate an inhalable aerosol by heating an aerosol-forming substrate 21. The system 1 comprises an aerosol-generating article 10 which includes the substrate 21 to be heated, and an elongate aerosol-generating device 100 for heating the substrate 21 upon engaging the article 10 with the device 100.

As can be particularly seen in FIG. 1, the aerosol-generating article 10 has a substantially rod-shape resembling the shape of a conventional cigarette. In the present embodiment, the article 10 comprises five elements sequentially arranged in coaxial alignment: a distal front plug element 40, a substrate element 20, a first tube element 50, a second tube element 55, as well as a filter element 60 arranged at a proximal end of the article 10 which serves as a mouthpiece. The substrate element 20 comprises the aerosol-forming substrate 21 to be heated as well as an inductively heatable susceptor 30 in direct physical contact with substrate 21 for heating the substrate 21 by interaction of the susceptor 30 with an alternating magnetic field provided by the device 100. The inductive heating process will be described in more detail below. All of the aforementioned elements 20, 40, 50, 55 and 60 have a substantially cylindrical shape with substantially the same diameter. As further shown in FIG. 1 and FIG. 2, the five elements 20, 40, 50, 55 and 60 are circumscribed by an outer wrapper 70 such as to keep the elements together and to maintain the desired circular cross-sectional shape of the rod-like article 10. The wrapper 70 preferably is made of paper.

The aerosol-generating device 100 comprising a device housing 101 including a cavity 103 within a proximal portion 102 of the device 100 which is configured to removably receive at least a portion of the aerosol-generating article 10. For inserting the article 10 into the cavity 103, the device 100 comprises an insertion opening 105 at a proximal end face of the device housing 101.

As shown in FIG. 1 and FIG. 2, as well as in FIGS. 3a, 3b and FIGS. 4a, 4b, the aerosol-generating device of the present embodiment comprises a closure 107 that is reversibly movable relative to the device housing 101 between a closed position (see FIGS. 3a, 3b), in which the closure 107 covers the insertion opening 105, and an open position (see FIGS. 4a, 4b, as well as FIG. 1 and FIG. 2), in which the insertion opening 105 is unobstructed by the closure 107. Advantageously, the closure 107 securely closes the cavity 103 and thus the prevents debris from getting into the cavity unintentionally when no article 10 is present in the cavity 103, in particular when the device 100 is not in use. In the present embodiment, the closure 107 is a sliding closure that is slidably guided on the device housing 101. For this, the closure may comprise one or more guide members (not shown) each of which is slidably guided in a correspondingly formed guide groove 106 on the device housing 101 in a form-fitting manner.

Within the device housing 101, the device 100 further comprises a DC power supply 150 and a controller 160 for powering and controlling operation of the device 100.

For heating the substrate 21 in the article 10, the device 100 comprises an inductive heating arrangement 110 including an induction coil 118 for generating a high-frequency alternating magnetic field within the cavity 103. In the present embodiment, the induction coil 118 is a helical coil which is arranged in the proximal portion 102 of the device such as to circumferentially surround the cylindrical cavity 103. The coil 118 is arranged such that the susceptor 30 of the aerosol-generating article 10 experiences the magnetic field upon engaging the article 10 with the device 100. As mentioned above, the alternating magnetic field is used to inductively heat the susceptor 30 within the aerosol-generating article 10 when the latter is received in the cavity 103 (see FIG. 2). Thus, the alternating magnetic field may induce at least one of eddy currents and hysteresis losses in the susceptor 30, depending on the magnetic and electric properties of the specific susceptor material(s) As a consequence, the susceptor 30 heats up until reaching a temperature that is sufficient to vaporize the aerosol-forming substrate 21 surrounding the susceptor 30 within the article 10.

The system is configured such that upon insertion of the article 10 into the cavity 103 and upon activation of the heating arrangement 110, a user may puff on the filter element 60, whereby air is drawn into the cavity 103 at the rim of the insertion opening 105. This airflow further extends towards the distal end of the cavity 103 along a passage which is formed between the inner surface of the cylindrical cavity 103 and the outer surface of the cylindrical article 10. At the distal end of the cavity 103, the airflow enters the aerosol-generating article 10 through the distal front plug element 40 and further passes through the substrate element 20, the first and second tube elements 50, 55, and the filter element 60 where it finally exits the article 10 into the user's mouth. Thus, material vaporized from the aerosol-forming substrate 21 during operation of the device may be entrained into the airflow through the substrate element 20. Subsequently, when passing through the first and second tube elements 50, 55, and the filter element 60, the airflow including the vaporized material cools down such as to form an aerosol escaping the article 10 through the filter element 60.

FIG. 5 shows further details of the inductive heating arrangement 110. According to the present embodiment, the inductive heating arrangement 110 comprises a DC/AC inverter which is connect to the DC power supply 150 shown in FIGS. 1 and 2. The DC/AC inverter includes a Class-E power amplifier comprising the following components: a transistor switch 111 comprising a Field Effect Transistor T (FET), for example a Metal-Oxide-Semiconductor Field Effect Transistor (MOSFET), a transistor switch supply circuit indicated by the arrow 112 for supplying a switching signal (gate-source voltage) to the transistor switch 111, and an LC load network 113 comprising a shunt capacitor C1 and a series connection of a capacitor C2 and an inductor L2. The inductor L2 corresponds to the induction coil 118 shown in FIGS. 1 and 2 for generating an alternating magnetic field within the cavity 103. In addition, there is provided a choke L1 for supplying a DC supply voltage +V_DC from to the DC power supply 150. Also shown in FIG. 5 is the ohmic resistance R representing the total equivalent resistance or total resistive load 114, which—in use of the system, that is, when the article is inserted in the cavity 103 of the device 100—is the sum of the ohmic resistance of the inductor coil 118, marked as L2, and the ohmic resistance of the susceptor. Otherwise, in case no article is inserted in the cavity 103, the equivalent resistance or resistive load 114 only corresponds to the ohmic resistance of the inductor coil 118. Further details of the inductive heating arrangement 110 according to the present embodiment, in particular with regard to its working principle, are disclosed, for example, in WO 2015/177046A1 .

For various purposes, in particular for automatically starting or for disabling the heating process, it might be desirable to detect certain states which are related to the aerosol-generating article to be received in the cavity 103. Such a state may be, for example, the article type, the insertion, the presence, the absence, a position or a displacement of the article in the cavity 103. According to the present invention, this kind of state detection is realized via the heating arrangement 110 which advantageously enables to avoid additional assembly space for separate sensor means. The basic idea for detecting one or more of these states is to detect at least one property or a change of at least one property of the inductive heating arrangement 110 that depends on at least one of a type, a presence, an absence, a position and a movement of the susceptor 30 of the article 10 in the cavity 103. In the present embodiment, it is the total resistive load 114 of the heating arrangement 110 which is used as a property of the inductive heating arrangement that is indicative—inter alia—of the presence or the absence of an article 10 in the cavity 103. As explained above, the value of the total equivalent resistance or total resistive load 114 depends on the presence or absence of the susceptor 30 in the vicinity of the induction coil 118. When the article is inserted in the cavity 103 of the device 100, the total equivalent resistance 118 corresponds to the sum of the ohmic resistance of the inductor coil 118 and the ohmic resistance of the susceptor 30, whereas it corresponds to the ohmic resistance of the inductor coil 118 only, when no article is received in the cavity 103.

This change of the equivalent resistance 118 may be detected via the DC current I_DC provided from the DC power supply 150 to the inductive heating arrangement 110, that is, to the LC load network 113. For this, the aerosol-generating device comprises a current measurement device 140 arranged in series connection between the DC power supply 150 and the LC load network 113 (see FIG. 5). Accordingly, when an aerosol-generating article 10 is inserted into the cavity 103 of the device 100, the presence of the susceptor 30 increases the equivalent resistance 118 of the heating arrangement due to due to the higher resistive load 114 in presence of the susceptor 30. This in turn causes a decrease of the DC current feeding the inductive heating arrangement 110. The decrease of the DC current I_DC is detected by the current measurement device 140 which in turn may be used as a trigger signal to start a heating operation for heating the substrate 21. Vice versa, when an aerosol-generating article 10 is extracted from the cavity 103, the absence of the susceptor 30 is related to a lower value of the equivalent resistance 118 of the heating arrangement 110 due to the lower resistive load 114 in absence of the susceptor 30. This in turn causes a lower value of the DC current feeding the inductive heating arrangement 110. Both, the decrease as well as the increase or the respective higher or lower values of the DC current ΔI_DC, I_NA, I_A may be detected by the current measurement device 140 (see FIG. 6).

In order to reduce the overall power consumption when the aerosol-generating device 100 is in a state detection mode, the heating assembly preferably is not operated in a continuous mode, but in a pulsed mode. For this, the device 100 according to the present embodiment comprises a switch 130 that is arranged and configured to control a supply of power from the DC power supply 150 to the inductive heating arrangement 110. As can be seen in FIG. 5, the switch 130 is arranged in series connection between the DC power supply 150 and the LC load network 113. During the state detection, the switch 130 is intermittently opened and closed such as to generate power pulses for intermittently powering on the inductive heating arrangement 110. During a subsequent heating operation, the switch 130 may be permanently closed to continuously apply a DC voltage from the DC power supply to the inductive heating arrangement 110 in order to continuously heat the susceptor 30. Alternatively, the switch 130 may be intermittently closed and opened during heating operation such as to generate heating power pulses for a pulsed heating of the susceptor 30.

As further shown in FIG. 3, the switch 130 and the current measurement device 140 are both part of a control circuitry which also includes a microprocessor 160. The microprocessor 160 is configured to control the switch 130 such as to generate power pulses, to read out the measurement device 140 for measuring the current I_DC supplied from the DC power supply to the inductive heating arrangement 110 as well as to control the transistor switch driver circuit 112. The control circuitry may be part of or may be an overall controller of the aerosol-generating device 100. During state detection, the microprocessor 160 starts driving the switch 130 by closing it for a pre-determined closing time interval, thereby generating of a current pulse having a pulse duration T1 corresponding to the closing time interval. The pulse duration T1 may be in a range between 1 microsecond and 500 microseconds, in particular between 10 microseconds and 300 microseconds, preferably between 15 microseconds and 120 microseconds, most preferably between 30 microseconds to 100 microseconds. At the end of the closing time interval, the microprocessor 160 opens the switch 130 again for a pre-determined opening time interval, thereby interrupting the current passage to the heating arrangement 110. The opening time interval corresponds to the time interval between two consecutive power pulses, which for article detection may be in a range between 50 milliseconds and 2 seconds, in particular between 100 milliseconds and 2 seconds, preferably between 500 milliseconds and 1 second. Closing and opening of the switch 130 may occur at regular time intervals such as to generate periodic power pulses for periodically powering on the inductive heating arrangement 110. Thus, the sum of the closing time interval and the opening time interval, or the sum of the pulse duration and the time interval between two consecutive power pulses corresponds to the periodicity of the pulse series. In general, the time interval between two consecutive probe power pulses T2 should be selected such as to balance the effect of energy depletion and user experience performance. The pulse duration T1 should be kept as minimal as possible but such to provide a reliable measurement of current pulse.

FIG. 6 is a graph showing an exemplary embodiment of a series of current pulses I_DC over time t, with a pulse duration T1 of 100 microseconds and a time interval between two consecutive power pulses T2 of 1 second. It will be appreciated that these values are only exemplary and may change. As long as no aerosol-generating article has been inserted, the current measuring device 140 measures for each pulse a current having a value I_NA (where the “NA” stands for “no article”). As explained, the measured value I_NA depends on the ohmic load 114, which equals the ohmic resistance of the inductor L2. In contrast, when user inserts an article 10 into the cavity 103, the ohmic load 114 is increased, since now the ohmic load equals the ohmic resistance of the inductor L2 and the ohmic resistance of the susceptor 30. Due to the increase of the ohmic load the current absorbed by heating assembly decreases. Accordingly, the current measuring device 140 measures a current pulse having a value of I_A (where the “A” stands for “article inserted”) which is lower than I_NA. The difference ΔI_DC between I_NA and I_A is recorded by the microcontroller 160 which triggers the start of the heating mode.

According to the invention, it has been found that any state detection involving the heating arrangement 110 consumes the least amount of energy if it is only actively energized when the state detection is actually needed. Typically, state detection is primarily needed at the start of a user experience shortly in advance to the actual heating operation of the device 100, that is, in a situation when the heating arrangement 110 is actually not yet active but about to be used. In order to provide a suitable trigger to activate the state detection, the present invention suggests to use the position and/or movement of closure 107, in particular the open position and/or the movement to the open position, since this is a well suited indicator for the start of a user experience. Vice versa, closing the closure 107 of the cavity may be a well suited indicator for the end of a user experience and, thus, may be a well suited trigger to stop a heating operation of the device. Advantageously, using the position and/or movement of the closure 107 as trigger does not require any additional user interaction with the device, such as pushing a button. Instead, this trigger advantageously exploits an action taken by the user at the start or the end of a user experience anyway.

In order to make the position and/or movement of the closure 107 available as a trigger, the aerosol-generating device 100 comprises a closure detector 108 arranged and configured to detect at least one of: when the closure 107 is in the open position or when the closure 107 moves from the closed position to the open position. The closure detector 108 is operatively connected to the control circuitry of the device 100 which in turn is configured to start the state detection by energizing the inductive heating arrangement 110 in response to a signal from the closure detector 108 indicating that the closure is in the open position or moves from the closed position to the open position, respectively.

In the present embodiment, the closure detector 108 is a magnetic closure detector 108, which comprises a permanent magnet 108a attached to the closure 107 and a magnetic sensor 108b stationarily arranged in the device housing 101 such that the magnetic sensor 108b senses a magnetic field of the permanent magnet 108a when the closure 107 is in or moves into the open position (see FIG. 4a and FIG. 4b). In particular, the permanent magnet 108a and the magnetic sensor 100b may be arranged such that the magnetic sensor 100b senses a magnetic field of the permanent magnet 108a only when the closure 107 is in the open position. Advantageously, this arrangement ensures that the opening can be reliably detected, in particular without external interference. To ensure such an interference-free detection, the permanent magnet 108a preferably is arranged next to the magnetic sensor 108b at a distance of at most 3 millimeters, in particular at most 2.5 millimeters, when the closure 107 is in the open position (see FIG. 4a and FIG. 4b). Vice versa, the permanent magnet 108a preferably is distanced from the magnetic sensor 108b by at least 40 millimeters, when the closure 107 is in the closed position (see FIG. 3a and FIG. 3b).

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A +5 percent A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device for heating an aerosol-forming substrate configured to form an inhalable aerosol when heated, the aerosol-generating device comprising:
a device housing comprising a cavity configured to removably receive at least a portion of an aerosol-generating article, the aerosol-generating article including the aerosol-forming substrate and an inductively heatable susceptor configured to heat the aerosol-generating substrate, wherein the cavity comprises an insertion opening configured for insertion of the aerosol-generating article into the cavity;
a closure reversibly movable relative to the device housing between a closed position, in which the closure covers the insertion opening, and an open position, in which the insertion opening is unobstructed by the closure;
an inductive heating arrangement configured to generate an alternating magnetic field within the cavity for inductively heating the inductively heatable susceptor of the aerosol-generating article when the aerosol-generating article is received in the cavity;
a closure detector arranged and configured to detect at least one of: when the closure is in the open position or when the closure moves from the closed position to the open position; and
a control circuitry operatively connected to the inductive heating arrangement and the closure detector and configured to:
energize the inductive heating arrangement in response to a signal from the closure detector indicating that the closure is in the open position or moves from the closed position to the open position, respectively,
determine, during energizing the inductive heating arrangement, at least one property or a change of at least one property of the inductive heating arrangement that depends on at least one of a type, a presence, an absence, a position, and a movement of the inductively heatable susceptor in the cavity, and
detect at least one specific state related to the aerosol-generating article based on the determined property or the determined change of the property of the inductive heating arrangement.

17. The aerosol-generating device according to claim 16, wherein the control circuitry is further configured to detect at least one of an article type, an insertion, a presence, an absence, a position, and a displacement of the aerosol-generating article in the cavity based on the determined property or the determined change of the property of the inductive heating arrangement.

18. The aerosol-generating device according to claim 16, wherein the control circuitry is further configured to generate power pulses configured to intermittently power on the inductive heating arrangement and to determine during one or more power pulses the at least one property or the change of the at least one property of the inductive heating arrangement.

19. The aerosol-generating device according to claim 16, wherein the closure detector is arranged and configured to further detect at least one of: when the closure is in the closed position or when the closure moves from the open position to the closed position.

20. The aerosol-generating device according to claim 19, wherein the control circuitry is further configured to stop energizing the inductive heating arrangement in response to a signal from the closure detector indicating that the closure is in the closed position or when the closure moves from the open position to the closed position, respectively.

21. The aerosol-generating device according to claim 16, wherein the closure detector comprises one of a magnetic closure detector, an optical closure sensor, a capacitive closure detector, an inducive closure detector, and an electromechanical switch.

22. The aerosol-generating device according to claim 21, wherein for detecting when the closure is in the open position or when the closure moves from the closed position to the open position, the magnetic closure detector comprises at least one magnetic sensor stationarily arranged in the device housing and at least one associated permanent magnet attached to the closure such that the magnetic sensor senses a magnetic field of the associated permanent magnet when the closure is in or moves to the open position.

23. The aerosol-generating device according to claim 21, wherein for detecting when the closure is in the open position or when the closure moves from the closed position to the open position, the magnetic closure detector comprises at least one magnetic sensor stationarily arranged in the device housing and at least one associated permanent magnet attached to the closure such that the magnetic sensor senses a magnetic field of the associated permanent magnet only when the closure is in the open position.

24. The aerosol-generating device according to claim 22,
wherein the at least one magnetic sensor is arranged next to the at least one associated permanent magnet at a distance of at most 3 millimeters when the closure is in the open position, and/or
wherein the at least one magnetic sensor is distanced from the associated permanent magnet by at least 5 millimeters when the closure is in the closed position.

25. The aerosol-generating device according to claim 22,
wherein the at least one magnetic sensor is arranged next to the at least one associated permanent magnet at a distance of at most 2.5 millimeters when the closure is in the open position, and/or
wherein the at least one magnetic sensor is distanced from the associated permanent magnet by at least 15 millimeters when the closure is in the closed position.

26. The aerosol-generating device according to claim 21,
wherein the optical closure detector comprises a light sensor configured to detect light, and
wherein the light sensor is arranged so as to be at least partially covered by the closure or by a cover attached to or arranged at the closure when the closure is in the open position or in the closed position, and unobstructed by the closure or by the cover attached to or arranged at the closure when the closure is in closed position or in the open position, respectively.

27. The aerosol-generating device according to claim 21,
wherein the optical closure detector comprises a light emitter and a light receiver configured to sense light transmitted from the light emitter, and
wherein the light emitter and the light receiver are arranged such that light transmitted from the light emitter towards the light receiver is blocked by the closure or by a cover attached to or arranged at the closure when the closure is in the open position or in the closed position, and unblocked by the closure or by the cover attached to the closure when the closure is in closed position or in the open position, respectively.

28. The aerosol-generating device according to claim 21, wherein the electromechanical switch is activated by the closure or by an actuator attached to or arranged at the closure when the closure is in the open position or in the closed position, and deactivated by the closure or by the actuator attached to the closure when the closure is in closed position or in the open position, respectively.

29. The aerosol-generating device according to claim 21, wherein the electromechanical switch is activated by the closure or by an actuator attached to or arranged at the closure when the closure moves from the open position to the closed position or when the closure moves from the closed position to the open position.

30. The aerosol-generating device according to claim 29, wherein the electromechanical switch is deactivated by the closure or by the actuator attached to or arranged at the closure when the closure moves from the closed position to the open position or when the closure moves from the open position to the closed position.

31. The aerosol-generating device according to claim 16, wherein the closure is one of: a sliding closure slidably guided on the device housing between the open position and the closed position, a pivotal closure pivotally mounted to the device housing, and an iris diaphragm closure.

32. The aerosol-generating device according to claim 16, wherein the control circuitry is further configured to at least one of:
start a heating operation of the inductive heating arrangement in response to detecting the insertion of the aerosol-generating article into the cavity,
disable a heating operation of the inductive heating arrangement in response to detecting the absence of the aerosol-generating article from the cavity.

33. An aerosol-generating system comprising an aerosol-generating device according to claim 16 and an aerosol-generating article for the aerosol-generating device, wherein the aerosol-generating article is removably receivable in the cavity of the aerosol-generating device and comprises at least one aerosol-forming substrate and at least one inductively heatable susceptor configured to heat the substrate by interaction of the susceptor with the alternating magnetic field provided by the inductive heating arrangement of the device.
